(19) United States
(12) Patent Application Publication
(10) Pub. No.: US 2026/0059271 A1
(43) Pub. Date: Feb. 26, 2026

(54) PRECIPITATION MONITORING METHOD AND APPARATUS BASED ON SENSING SERVICE, AND DEVICE AND STORAGE MEDIUM

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/105,519

(22) PCT Filed: Aug. 26, 2022
(86) PCT No.: PCT/CN2022/115231

§ 371 Date: Feb. 21, 2025

(51) Int. Cl. H04W 4/30; G01W 1/14; H04W 4/12; H04W 60/00

(52) U.S. Cl. CPC H04W 4/30; G01W 1/14; H04W 4/12; H04W 60/00

(57) ABSTRACT

The present disclosure relates to the technical field of wireless communications, in particular to a precipitation monitoring method and apparatus based on a sensing service, and a device and a storage medium. The method comprises: receiving a first message, which is sent by a sensing requester device, wherein the first message carries an event trigger parameter of a precipitation monitoring service, and the event trigger parameter is used for indicating a reporting event which is used for triggering reporting of sensing data of the precipitation monitoring service; sending a second message to an access network function according to the first message, wherein the second message carries the event trigger parameter; and receiving the sensing data, which is reported by the access network function. In this way, the present disclosure can provide a precipitation monitoring sensing service on the basis of a mobile network.

### TECHNICAL FIELD

The present disclosure relates to the technical field of wireless communication, and in particular to a precipitation monitoring method and apparatus based on a sensing service, a device and a storage medium.

### BACKGROUND

At present, precipitation monitoring is usually achieved by using a professional precipitation monitoring device (e.g., a rain gauge). In order to monitor precipitation in a region, it is often necessary to deploy a monitoring network in the region. The monitoring network contains a large number of precipitation monitoring devices. Because the professional precipitation monitoring device is expensive, the deployment of the monitoring network requires a large amount of investment, and the deployment scale of the monitoring network is limited.

In recent years, with the continuous developments and combination of wireless technologies and sensing methods, the wireless sensing technology has become a hot topic of research. The wireless sensing technology can be combined with communication technology (technologies) such as the fifth generation (5G) mobile communication technology to provide a wireless sensing service based on communication system(s). In particular, due to the large number and wide distribution of access network functional entities and terminal devices, they have become the preferred providers for sensing service(s).

Based on the continuously developing wireless sensing technology, it is possible to consider using an access network functional entity to replace the professional precipitation monitoring device to achieve precipitation monitoring. However, in the related art, there is no solution for implementing precipitation monitoring based on a mobile network.

Therefore, how to provide a sensing service for precipitation monitoring based on a mobile network is an urgent problem to be solved.

### SUMMARY

The present disclosure provides a precipitation monitoring method and apparatus based on a sensing service, a device and a storage medium, which are capable of providing a sensing service for precipitation monitoring based on a mobile network.

In a first aspect, the present disclosure provides a precipitation monitoring method based on a sensing service. The method may be applied to a network function. The method includes: receiving a first message sent by a sensing requester device, where the first message carries an event trigger parameter for a precipitation monitoring service, and the event trigger parameter is used to indicate a reporting event for triggering reporting of sensing data of the precipitation monitoring service; sending a second message according to the first message, where the second message carries the event trigger parameter; and receiving the sensing data reported by an access network function.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the operation of sending the second message according to the first message may include: sending the second message to the access network function via a core network function.

In some possible implementations, before receiving the first message sent by the sensing requester device, the method may further include: receiving sensing capability information, where the sensing capability information is used to indicate that the access network function supports the precipitation monitoring service.

In some possible implementations, the operation of receiving the sensing capability information may include: receiving a registration request message, where the registration request message carries the sensing capability information.

In a second aspect, the present disclosure provides a precipitation monitoring method based on a sensing service. The method may be applied to an access network function. The method includes: receiving a second message, where the second message carries an event trigger parameter for a precipitation monitoring service, and the event trigger parameter is used to indicate a reporting event for trigger reporting of sensing data of the precipitation monitoring service; performing processing for the precipitation monitoring service according to the second message; and sending the sensing data to a network function in a case where the reporting event occurs.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the operation of receiving the second message may include: receiving the second message sent by the network function via a core network function.

In some possible implementations, before the operation of receiving the second message, the method may further include: sending sensing capability information, where the sensing capability information is used to indicate that the access network function supports the precipitation monitoring service.

In some possible implementations, the operation of sending the sensing capability information may include: sending a registration request message, where the registration request message carries the sensing capability information.

In a third aspect, the present disclosure provides a precipitation monitoring method based on a sensing service. The method may be applied to a sensing requester device. The method includes: sending a first message to a network function, where the first message carries an event trigger parameter for a precipitation monitoring service, and the event trigger parameter is used to indicate a reporting event for triggering reporting of sensing data of the precipitation monitoring service; and receiving the sensing data of the precipitation monitoring service and/or a sensing result of the precipitation monitoring service from the network function.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In a fourth aspect, the present disclosure provides a precipitation monitoring apparatus based on a sensing service. The apparatus may be set in a network function. The apparatus includes: a receiving module and a sending module. The receiving module is configured to receive a first message sent by a sensing requester device, where the first message carries an event trigger parameter for a precipitation monitoring service, and the event trigger parameter is used to indicate a reporting event for triggering reporting of sensing data of the precipitation monitoring service. The sending module is configured to send a second message according to the first message, where the second message carries the event trigger parameter. The receiving module is further configured to receive the sensing data reported by an access network function.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the sending module may be configured to send the second message to the access network function via a core network function.

In some possible implementations, the receiving module may be further configured to receive sensing capability information, where the sensing capability information is used to indicate that the access network function supports the precipitation monitoring service.

In some possible implementations, the receiving module may be configured to receive a registration request message, where the registration request message carries the sensing capability information.

In a fifth aspect, the present disclosure provides a precipitation monitoring apparatus based on a sensing service. The apparatus may be set in an access network function. The apparatus includes: a receiving module, a processing module and a sending module. The receiving module is configured to receive a second message, where the second message carries an event trigger parameter for a precipitation monitoring service, and the event trigger parameter is used to indicate a reporting event for triggering reporting of sensing data of the precipitation monitoring service. The processing module is configured to perform processing for the precipitation monitoring service according to the second message. The sending module is configured to send the sensing data to a network function in a case where the reporting event occurs.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the receiving module may be configured to receive the second message sent by the network function via a core network function.

In some possible implementations, the sending module may be further configured to send sensing capability information, where the sensing capability information is used to indicate that the access network function supports the precipitation monitoring service.

In some possible implementations, the sending module may be configured to send a registration request message, where the registration request message carries the sensing capability information.

In a sixth aspect, the present disclosure provides a precipitation monitoring apparatus based on a sensing service. The apparatus may be set in a sensing requester device. The apparatus includes: a receiving module and a sending module. The sending module is configured to send a first message to a network function, where the first message carries an event trigger parameter for a precipitation monitoring service, and the event trigger parameter is used to indicate a reporting event for triggering reporting of sensing data of the precipitation monitoring service. The receiving module is configured to receive the sensing data of the precipitation monitoring service and/or a sensing result of the precipitation monitoring service from the network function.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

It should be noted that the above-mentioned network function may be deployed inside a core network or outside the core network. In a case where the network function is deployed inside the core network, the network function may be understood as the first core network function, and the above-mentioned core network function may be understood as the second core network function. As an example, in the present disclosure, the first core network function may be a Sensing Application Function (SAF), and the second core network function entity may be an Access and Mobility Management function (AMF). However, it should be understood that the above-mentioned second core network function may also be other function(s) in the core network, and the present disclosure does not specifically limit this.

In a seventh aspect, the present disclosure provides a precipitation monitoring method based on a sensing service. The method may be applied to a core network device. The method includes: receiving a first message sent by a sensing requester device, where the first message carries an event trigger parameter for a precipitation monitoring service, and the event trigger parameter is used to indicate a reporting event for triggering reporting of sensing data of the precipitation monitoring service; sending a second message to an access network function according to the first message, where the second message carries the event trigger parameter; and receiving the sensing data reported by the access network function.

In some possible implementations, the event trigger parameter includes at least one of: a reporting period; a precipitation threshold.

In some possible implementations, the event trigger parameter includes the reporting period, and the reporting event is that the reporting period is reached.

In some possible implementations, the event trigger parameter includes the precipitation threshold, and the reporting event is that precipitation sensed by the access network function reaches the precipitation threshold.

In some possible implementations, the core network device includes: a first core network function and a second core network function; receiving the first message sent by the sensing requester device includes: receiving, by the first core network function, the first message sent by the sensing requester device; sending the second message to the access network function according to the first message includes: sending, by the first core network function, the second message to the second core network function according to the first message; and sending, by the second core network function, the second message to the access network function.

In the present disclosure, the first core network function may be an SAF, and the second core network function entity may be an AMF.

In some possible implementations, the core network device includes a first core network function and a second core network function; receiving the sensing data reported by the access network function includes: receiving, by the second core network function, the sensing data reported by the access network function; the method further includes: sending, by the second core network function, the sensing data to the first core network function.

In some possible implementations, the method may further include: receiving, by the second core network function, sensing capability information from the access network function, where the sensing capability information is used to indicate that the access network function supports the precipitation monitoring service; and sending, by the second core network function, the sensing capability information to the first core network function. In an eighth aspect, the present disclosure provides a core network device. The core network device is configured to: receive a first message sent by a sensing requester device, where the first message carries an event trigger parameter for a precipitation monitoring service, and the event trigger parameter is used to indicate a reporting event for triggering reporting of sensing data of the precipitation monitoring service; send a second message to an access network function according to the first message, where the second message carries the event trigger parameter; and receive the sensing data reported by the access network function.

In some possible implementations, the event trigger parameter may include at least one of: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the core network device may include: a network function and a core network function. The network function is configured to: receive a first message sent by a sensing requester device; and send a second message to the core network function according to the first message. The core network function is configured to: receive the second message and send the second message to the access network function; receive the sensing data reported by the access network function, and send the sensing data to the network function.

In some possible implementations, the core network function may be further configured to: receive sensing capability information from the access network function, where the sensing capability information is used to indicate that the access network function supports the precipitation monitoring service; and send the sensing capability information to the network function. The network function may be further configured to: receive the sensing capability information sent by the core network function.

In a ninth aspect, the present disclosure provides an electronic device. The electronic device includes: a memory configured to store computer executable instructions; and a processor connected to the memory. The processor is configured to execute the computer executable instructions in the memory to implement the precipitation monitoring method based on the sensing service as described in any one of the first to third aspects and possible implementations thereof.

In a tenth aspect, the present disclosure provides a computer storage medium. The computer storage medium stores computer executable instructions. After the computer executable instructions are executed by a processor, the precipitation monitoring method based on the sensing service as described in any one of the first to third aspects and possible implementations thereof can be implemented.

In an eleventh aspect, the present disclosure provides a computer program product. The computer program product includes a computer code. After the computer code is executed by a processor, the precipitation monitoring method based on sensing service as described in any one of the first to third aspects and possible implementations thereof can be implemented.

In the present disclosure, the event trigger parameter required for implementing the precipitation monitoring service is sent to the access network function, and the access network function performs precipitation monitoring and feeds back the sensing data according to the received event trigger parameter. In this way, the present disclosure can provide the sensing service for precipitation monitoring based on the use of a mobile network, thereby realizing large-scale and low-cost precipitation monitoring.

It should be understood that the fourth to eleventh aspects of the present disclosure are consistent with the technical solutions of the first to third aspects of the present disclosure, and the beneficial effects achieved by respective aspects and their corresponding feasible implementations are similar, and repeated descriptions will be omitted here.

### BRIEF DESCRIPTION OF THE DRAWINGS

FIG. 1 is a schematic diagram of a scenario of precipitation monitoring based on a sensing service in an embodiment of the present disclosure.

FIG. 2 is a schematic diagram of a structure of a communication system in an embodiment of the present disclosure.

FIG. 3 is a schematic flowchart of a specific embodiment of a precipitation monitoring method based on a sensing service in an embodiment of the present disclosure.

FIG. 4 is a schematic flowchart of a precipitation monitoring method based on a sensing service in an embodiment of the present disclosure.

FIG. 5 is a schematic flowchart of another precipitation monitoring method based on a sensing service in an embodiment of the present disclosure.

FIG. 6 is a schematic flowchart of another precipitation monitoring method based on a sensing service in an embodiment of the present disclosure.

FIG. 7 is a schematic diagram of a structure of a precipitation monitoring apparatus based on a sensing service in an embodiment of the present disclosure.

FIG. 8 is a schematic diagram of a structure of another precipitation monitoring apparatus based on a sensing service in an embodiment of the present disclosure.

FIG. 9 is a schematic diagram of a structure of an electronic device in an embodiment of the present disclosure.

FIG. 10 is a schematic diagram of a structure of a network device in an embodiment of the present disclosure.

### DETAILED DESCRIPTION

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the invention. Rather, they are merely examples of apparatuses and methods consistent with some aspects of embodiments of the present disclosure as detailed in the appended claims.

The terms used in embodiments of the present disclosure are for the purpose of describing example embodiments only and are not intended to limit the embodiments of the present disclosure. As used in the embodiments of the present disclosure and the appended claims, the singular forms “a/an” and “the” are intended to include a plural form as well, unless the context clearly dictates otherwise. It will also be understood that the term “and/or” as used herein refers to and includes any one or all possible combinations of one or more of associated listed items.

It should be understood that although the terms “first”, “second”, “third”, etc. may be used to describe various elements in the embodiments of the present disclosure, these elements should not be limited to these terms. These terms are only used to distinguish elements of the same type from each other. For example, without departing from the scope of the embodiments of the present disclosure, “first element” may also be called “second element”, and similarly, “second element” may also be called “first element”. Depending on the context, the word “if” as used herein may be interpreted as “when” or “in a case where . . . ” or “in response to determining . . . ”.

Furthermore, in the description of the embodiments of the present disclosure, “and/or” is only a description of an association relationship of associated objects, indicating that three relationships may exist. For example, A and/or B may represent the following three situations: A exists alone, A and B exist at the same time, and B exists alone. In addition, in the description of the embodiments of the present disclosure, “multiple/a plurality of” may refer to two or more than two.

With the developments of AI technologies, the intelligence of many industries has been greatly promoted, among which the sensing technology has become an important technical foundation. The sensing technology based on a radar technology is widely used in smart transportation, the autonomous driving technical field, or people counting, and so on. At present, the radar-based sensing technology mainly relies on a dedicated radar device. However, the dedicated radar device has defects such as high cost and inflexible deployment, and thus it is mainly used in specific scenarios.

With the continuous developments and integration of wireless technologies and sensing methods, the wireless sensing technology has become a hot topic of research. The wireless sensing technology can be combined with communication technology (technologies) such as the fifth generation (5G) mobile communication technology to provide a sensing service based on communication system(s). In particular, due to the large number and wide distribution of access network functional entities and terminal devices, they have become the preferred providers for sensing service(s). In some scenarios, access network device(s) can be used to provide sensing service(s), such as detecting animal or object intrusions on highways, sensing weather conditions, etc.

At present, precipitation monitoring is usually achieved by using a professional precipitation monitoring device (e.g., a rain gauge). In order to monitor precipitation in a region, it is often necessary to deploy a monitoring network in the region. The monitoring network contains a large number of precipitation monitoring devices. Because professional precipitation monitoring device is expensive, the deployment of the monitoring network requires a large amount of investment, and the deployment scale of the monitoring network is limited.

Based on the continuously developing wireless sensing technology, it is possible to consider using an access network functional entity to replace the professional precipitation monitoring device to achieve precipitation monitoring. However, in the related art, there is no solution for implementing precipitation monitoring based on a mobile network.

Therefore, how to provide a sensing service for precipitation monitoring based on a mobile network is an urgent problem to be solved.

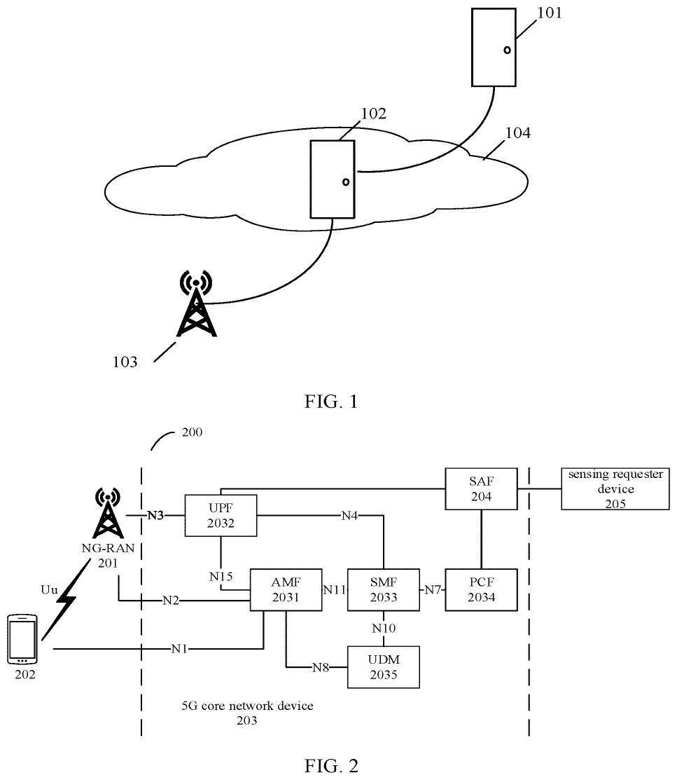

FIG. 1 is a schematic diagram of a scenario of precipitation monitoring based on a sensing service in an embodiment of the present disclosure. The scenario shown in FIG. 1 includes a requester device 101, a Sensing Application Function (SAF) 102, and an access network function 103.

The requester device 101 may be a device for requesting a precipitation monitoring service. For example, the requester device 101 may be a station device set in a meteorological bureau or a meteorological station. For another example, the requester device 101 may be a terminal device of a user.

The SAF 102 is used to manage wireless sensing service(s) such as a precipitation monitoring service. In particular, the SAF 102 may be a function owned or trusted by a service provider and authenticated and authorized by the requester device 101.

The access network function 103 has a wireless sensing capability, especially wireless sensing of precipitation, that is, performing processing for the precipitation monitoring service. Specifically, a wireless signal transmitted by an antenna of the access network function 103 is attenuated due to presence of atmospheric components when the wireless signal propagates in the atmosphere. In rainy weather, on the basis of the above attenuation, there is additional attenuation caused by rain. As a result, the propagation path attenuation of the wireless signal increases. In particular, the degree of attenuation (or called rain attenuation) caused by rain depends on the size and distribution of water droplets. In this way, the precipitation can be obtained by quantifying and modeling the measured value(s) of the wireless signal. As an example, the access network function 103 may be a base station device, such as gNB, eNB, etc.

In the scenario shown in FIG. 1, in order to obtain precipitation information at a certain location/region, the requester device 101 may send a request to the SAF 102 to request provision of the precipitation monitoring service. After receiving the request, the SAF 102 may indicate an access network function 103 located at the location/region to perform wireless sensing to implement precipitation monitoring.

In FIG. 1, the SAF 102 is deployed inside a core network 104. However, it should be noted that the SAF 102 may be located inside the core network 104 or outside the core network. In the former case, the SAF 102 may be a network function deployed by an operator. In this case, the SAF 102 may be a core network function. In the latter case, the SAF 102 may be a network function deployed by a service provider. In this case, the SAF 102 may be a non-core network function and is in a communication connection with the core network through a preset communication interface.

In addition, only one access network function 103 is shown in FIG. 1. It can be understood that in actual applications, there may be a plurality of access network functions 103 providing the sensing service.

In order to provide the wireless sensing service, an embodiment of the present disclosure provides a communication system. FIG. 2 is a schematic diagram of a structure of a communication system in an embodiment of the present disclosure. As shown in FIG. 2, the communication system 200 may include an access network function and a core network function, which may be an access network function and a core network function of any generation of communication system. For example, taking a 5G network as an example, the communication system 200 may include a 5G Access Network (AN) and a 5G Core network (5GC). In the subsequent embodiments of the present disclosure, the 5G network system is used as an example for explanation. Of course, those skilled in the art can understand that the technical solutions of the present disclosure may be used in any generation of communication system, including but not limited to a 5G communication system. As an example, the 5G access network may include a Next Generation Radio Access Network (NG-RAN) 201. The NG RAN 201 communicates with a terminal device 202 via a Uu interface.

The 5G core network 203 may include: an Access and Mobility Management Function (AMF) 2031, a User Plane Function (UPF) 2032, a Session Management Function (SMF) 2033, a Policy Control Function (PCF) 2034, Unified Data Management (UDM) 2035, etc.

The Sensing Application Function (SAF) 204 may be located within the 5G core network 203. That is, the SAF 204 may be a core network function (which may be referred to as a first core network function) in the 5G core network 203, and connected to the PCF 2034 in the 5G core network 203. In some cases, the SAF 204 may also be located outside the 5G core network 203, that is, the SAF may be a network function in the 5G communication system, and connected to the UPF 2032 in the 5G core network 203.

The sensing requester device 205 is located outside the 5G core network and is in communication connection with the SAF 204. It should be noted that the communication connection may be a communication connection based on the Internet protocol (Internet protocol) or a connection implemented in other ways. In an embodiment, the communication connection may be based on a hypertext transfer protocol (HTTP) or a secure hypertext transfer protocol (hypertext transfer protocol over secure socket layer, HTTPS). In an embodiment, the communication connection may be a connection established based on a Session Initialization Protocol (SIP). In order to achieve the above communication connection, an interface may be deployed between the SAF 204 and the sensing requester device 205, or the communication connection may be implemented in other ways. The interface deployed between the sensing requester device 205 and the SAF 204 may be a communication interface in any cellular mobile network. In an example, an interface may be deployed between the SAF 204 and the sensing requester device 205, and the interface may be a communication interface defined or to be defined by a 5G communication system and its future evolved version(s).

In an embodiment of the present disclosure, the above-mentioned communication system may also include other network functions, which are not specifically limited in the embodiment of the present disclosure.

It should be noted that the network function may also be described as a network function entity, a network element, a network function component, a network function module, or a network device, etc. The core network function may also be described as a core network function entity, a core network network element, a core network function component, a core network function module, or a core network device, etc.

In the above communication system 200, the terminal device 202 may access the 5G core network 203 through the 3rd generation partnership project (3GPP) technology. Specifically, the terminal device 202 may access the 5G core network 203 via a 3GPP access network device.

In the above communication system, the UDM 2035 has a function of unified data management, and is mainly responsible for managing subscription data, user access authorization or other functions.

The PCF 2034 has a policy control function and is mainly responsible for policy decisions related to charging policies for sessions and service flows, Quality of Service (QoS) bandwidth guarantees and policies, etc. In this architecture, the PCF 2034 connected to the AMF 2031 and the SMF 2033 may correspond to AM PCF (PCF for access and mobility control) and SM PCF (PCF for session management), respectively. In actual deployment scenarios, the AM PCF and the SM PCF may not be the same PCF entity.

The SMF 2033 has a session management function and mainly performs functions such as session management, execution of control policies issued by the PCF 2034, selection of UPF 2032, allocation of an Internet Protocol (IP) address for the terminal device 202, and so on.

The AMF 2031 has access and mobility management functions, and mainly performs functions such as mobility management, access authentication/authorization, etc. In addition, the AMF 2031 is also responsible for transferring user policies between the terminal device 202 and the PCF 2034.

The UPF 2032 is a user plane functional entity, and as an interface with a data network, the UPF 2032 completes functions such as User Plane (UP) data forwarding, charging statistics based on session/flow-level, or bandwidth limitation.

The functions of each interface are described as follows:

N7: this is the interface between the PCF 2034 and the SMF 2033 and is used to issue control policies for Packet Data Unit (PDU) session granularity and service data flow granularity.

N3: this is a communication interface between the UPF 2032 and the NG-RAN 201.

N15: this is the interface between the PCF 2034 and the AMF 2031 and is used to deliver a UE policy and an access control related policy.

N4: this is an interface between the SMF 2033 and the UPF 2032 and is used for transferring information between the control plane and the UP, including controlling the delivery of a forwarding rule for the UP, a QoS control rule, a traffic statistics rule, etc. and reporting of UP information.

N11: this is an interface between the SMF 2033 and the AMF 2031 and is used for transferring PDU session tunnel information between the NG-RAN 201 and the UPF 2032, transferring control message(s) sent to the terminal device 202, transferring radio resource control information sent to the NG-RAN 201, etc.

N2: this is an interface between the AMF 2031 and the NG-RAN 201 and is used for transferring radio bearer control information from the core network side to the NG-RAN 201, etc.

N1: this is an interface between the AMF 2031 and the terminal device 202 and is independent of access and is used for transferring QoS control rule(s), etc. to the terminal device 202.

N8: this is an interface between the AMF 2031 and the UDM 2035 and is used for the AMF 2031 to obtain access and mobility management related subscription data and authentication data from the UDM 2035, and for the AMF 2031 to register UE's current mobility management related information with the UDM 2035.

N10: this is an interface between the SMF 2033 and the UDM 2035 and is used for the SMF 2033 to obtain session management related subscription data from the UDM 2035, and for the SMF 2033 to register UE current session related information with the UDM 2035.

The terminal device 202 may be a terminal device with a wireless communication function, and may also be called User Equipment (UE). The terminal device may be deployed on land, including indoors or outdoors, handheld, wearable or vehicle-mounted terminal device. The terminal device may also be deployed on the water surface (such as ship, etc.). The terminal device may also be deployed in the air (such as airplane, balloon and satellite, etc.). The terminal device may be a mobile phone, a tablet computer, a computer with a wireless transceiving function, a Virtual Reality (VR) terminal device, an Augmented Reality (AR) terminal device, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, etc. The terminal device may also be a handheld device a with wireless communication function, a vehicle-mounted device, a wearable device, a computing device or other processing device connected to a wireless modem, etc. Optionally, the terminal device may be called different names in different networks, such as: a terminal apparatus, an access terminal, a user unit, a user station, a mobile station, a mobile terminal, a remote station, a remote terminal, a mobile device, a user terminal, a terminal, a wireless communication device, a user agent or a user apparatus, a cellular phone, a cordless phone, a Session Initiation Protocol (SIP) phone, a Wireless Local Loop (WLL) station, a Personal Digital Assistant (PDA), a terminal device in the 5G network or a future evolved network, etc.

The NG-RAN 201 may be a device at the access network side for supporting the terminal device 202 to access the wireless communication system. For example, the NG-RAN 201 may be a next generation NodeB (gNB) in a 5G access technology communication system, a Transmission Reception Point (TRP), a relay node, an Access Point (AP), etc.

It should be noted that in the communication system shown in FIG. 2, the functions and interfaces of each device are only illustrative, and not all functions of each device are required when applied in the embodiments of the present disclosure. All or part of the devices of the core network may be physical entity devices or virtualized devices, which are not limited here. Of course, the communication system in the embodiments of the present disclosure may also include other devices not shown in FIG. 2, which are not limited here.

In order to solve the above-mentioned problem, an embodiment of the present disclosure provides a precipitation monitoring method based on a sensing service. The method may be applied to the above-mentioned communication system.

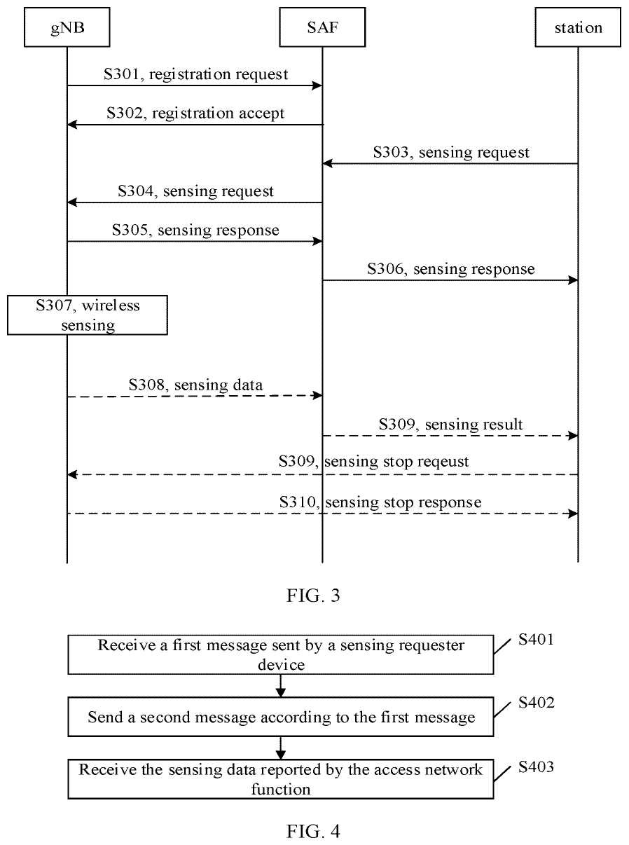

FIG. 3 is a schematic flowchart of a specific embodiment of a precipitation monitoring method based on a sensing service in an embodiment of the present disclosure. In the embodiment shown in FIG. 3, the access network function may be a gNB, the network function may be a SAF, and the sensing requester device may be a station.

As shown in FIG. 3, the precipitation monitoring method based on a sensing service may include: S301 to S310.

In S301, the gNB sends a registration request to the SAF.

The registration request may be sent from the gNB to the SAF in the form of a registration request message.

In an embodiment, the registration request message may carry sensing capability information of the gNB. The sensing capability information is used to indicate the capability of the gNB to perform wireless sensing. For example, the sensing capability information may include indication information indicating whether the gNB supports precipitation monitoring. In other words, the sensing capability information may indicate that the gNB supports precipitation monitoring; or, the sensing capability information may indicate that the gNB does not support precipitation monitoring. For another example, the sensing capability information may also include a wireless sensing parameter of the gNB for precipitation monitoring. The wireless sensing parameter may include at least one of the following: a sensing distance, a sensing value range, a sensing accuracy.

The sensing distance may be related to the length of a propagation path of a wireless signal in the procedure of being sent from the gNB to returning to the gNB. Generally speaking, the greater the sensing distance, the longer the propagation path; the smaller the sensing distance, the shorter the propagation path. It can be understood that compared with a shorter propagation path, a longer propagation path can make a monitored value closer to an actual value, thereby obtaining more accurate sensing data.

The sensing value range may be a value range of precipitation that the gNB can sense. For example, the sensing value range may be 0 to infinity. It is understandable that, limited by the transmit power of the gNB antenna, when excessive precipitation causes excessive path attenuation, the gNB may not be able to obtain data because the signal strength of the received wireless signal is too small. Therefore, the sensing value range usually has an upper limit.

The sensing accuracy may be the accuracy of the precipitation that the gNB can sense. It is understandable that the sensing accuracy may be related to the transmit power, the receiver performance, etc. For example, the sensing accuracy may be 0.1 mm/day, 0.5 mm/day, 1 mm/day, etc.

In an embodiment, the registration request message may carry identity information of the gNB. The identity information is used to identify the gNB.

It is understandable that the gNB may send the registration request to the SAF in multiple ways. In a first way, the gNB may send the registration request to the SAF according to an IP address of the SAF. In a second way, the gNB may send the registration request to the SAF via the AMF (i.e., the second core network function). It should be noted that the gNB may also send the registration request to the SAF in other ways, which is not specifically limited in the embodiments of the present disclosure.

In S302, the SAF sends a registration accept to the gNB.

After the registration request from the station is received in S301, the SAF completes the registration of the gNB.

Specifically, during the registration procedure of the gNB by the SAF, the SAF may obtain the identity information and/or sensing capability information of the gNB from the received registration request message, and may save the identity information and/or the sensing capability information of the gNB.

After the registration of the gNB is completed, the SAF may send the registration accept message to the gNB. The registration accept message indicates that the registration of the gNB is completed.

Corresponding to the gNB sending the registration request to the SAF in S301, the SAF may send the registration accept to the gNB in multiple ways. In a first way, the SAF may send the registration accept to the gNB according to an IP address of the gNB. In a second way, the SAF may send the registration accept to the gNB via the AMF. It should be noted that the SAF may also send the registration accept to the gNB in other ways, which is not specifically limited in the embodiments of the present disclosure.

It is understandable that the registration request message sent by the gNB in S301 may not carry the sensing capability information of the gNB; instead, after the gNB registers with the SAF, the gNB sends a reporting message to the SAF. The reporting message carries the sensing capability information of the gNB.

Similarly, the gNB may send the reporting message to the SAF in multiple ways. In a first way, the gNB may send the reporting message to the SAF according to the IP address of the SAF. In a second way, the gNB can may the reporting message to the SAF via the AMF. It should be noted that the gNB may also send the reporting message to the SAF in other ways, which is not specifically limited in the embodiments of the present disclosure.

In S303, the station sends a sensing request to the SAF.

In a case where the station needs to obtain precipitation information at a location, the station may send the sensing request to the SAF. The sensing request may be sent by the station to the SAF in the form of a sensing request message (also referred to as a first message).

It can be understood that the sensing request message carries an event trigger parameter for the precipitation monitoring service, and the event trigger parameter is used to indicate a reporting event for triggering reporting of sensing data of the precipitation monitoring service.

In an embodiment, the event trigger parameter may include at least one of the following: a reporting period, a precipitation threshold. The reporting period may indicate a period for the gNB to report the sensing data. It is understood that the reporting period may be set according to actual needs. For example, the reporting period may be 10 minutes, 30 minutes, 1 hour, 2 hours, or any other duration. The precipitation threshold may be a predetermined value which is to be reached by the precipitation sensed by the gNB.

In an embodiment, in a case where the event trigger parameter is the reporting period, the reporting event for triggering the gNB to report the sensing data may be that the reporting period is reached. For example, when the reporting period is 30 minutes, the gNB performs wireless sensing and reports the sensing data every 30 minutes. In an embodiment, the reporting period may be a single period. In this case, the reporting period in the event trigger parameter may be a fixed value. In an embodiment, the reporting period may be a variable period. In this case, the reporting period in the event trigger parameter may be complete time indication information. For example, the reporting period may be in the form of alternating multiple durations, such as 5 minutes, 10 minutes, 5 minutes, 10 minutes, and so on. For another example, the reporting period may be in the form of gradually increasing durations, such as 1 minute, 2 minutes, 4 minutes, 8 minutes, and so on.

In an embodiment, when the event trigger parameter is the precipitation threshold, the reporting event for triggering the gNB to report the sensing data may be that the precipitation sensed by the gNB reaches the precipitation threshold. It can be understood that the precipitation threshold may include one or more values. For example, the precipitation threshold may be 100 mm/day.

It can be understood that, in an embodiment, the sensing request message may also carry at least one of the following: identity information of the station, sensing location information, sensing time information. The identity information of the station is used to identify the station. The sensing location information is used to indicate the location where processing for the sensing service is performed. The sensing time information is used to indicate the time when the processing for the sensing service is performed.

In an embodiment, the sensing location information may represent a geographic location. For example, the sensing location information may be coordinate information of the geographic location in a positioning system. It is understandable that the positioning system may be a Global Positioning System (GPS), a Galileo satellite navigation system, a BeiDou navigation satellite system, a global navigation satellite system (GLONASS) system, a quasi-zenith satellite system (QZSS), etc. If the location represented by the sensing location information is a location point, the sensing location information may be a pair of coordinate values corresponding to the location point (for example, including a longitude coordinate value and a latitude coordinate value). If the location represented by the sensing location information is a location region, the sensing location information may be multiple pairs of coordinate values corresponding to multiple location points in the location region. In another embodiment, the sensing location information may represent the location of an administrative region. In this case, the sensing location information may, for example, be in at least one of the following forms: a postal code, an administrative region identifier or name, etc.

The sensing time information is used to indicate the time when processing for the sensing service is performed. The processing time may include at least one of the following: a start time, an end time, a duration. For example, the processing time may include the start time and the end time. For another example, the processing time may include the start time and the duration. For another example, the processing time may include only the end time. For another example, the processing time may include only the duration.

In an embodiment, the sensing request message may also carry at least one of the following: range requirement information, accuracy requirement information. The range requirement information may indicate a to-be-realized value range for precipitation monitoring required by the station. The accuracy requirement information may indicate a to-be-realized accuracy range of precipitation monitoring required by the station.

It should be noted that the sensing request message may also carry other information, which is not specifically limited in the embodiments of the present disclosure.

In S304, the SAF sends a sensing request to the gNB.

After the sensing request is received in S303, the SAF sends a sensing request to the gNB.

In an embodiment, the SAF sending the sensing request to the gNB may be implemented through the following procedure. The SAF determines an AMF and sends a sensing request to the determined AMF; the AMF determines a gNB and sends a sensing request to the determined gNB.

In an example, the SAF may determine the AMF based on the sensing location information carried in the sensing request message. For example, the AMF should meet the following condition(s): the coverage of at least one gNB connected to the AMF covers the location represented by the sensing location information; and/or, the distance between at least one gNB connected to the AMF and the location represented by the sensing location information is the shortest, or is less than or equal to a preset distance. In this case, the SAF may determine an AMF that meets the above condition(s) based on the sensing location information. It should be noted that in the embodiments of the present disclosure, “coverage” includes both full coverage and partial coverage (i.e., partial overlap).

It is understandable that the SAF may store and maintain relevant information of gNB(s) that supports (support) the precipitation monitoring service, such as identity information of the gNB(s), sensing capability information of the gNB(s), location information of the gNB(s). In this case, the SAF may determine a gNB based on the relevant information and the obtained sensing location information. Afterwards, the SAF may determine an AMF based on the relevant information of the gNB. In an embodiment, the SAF may obtain relevant information of the gNB from other function(s) in the core network based on the sensing location information, and then determine the AMF. In an embodiment, the SAF may obtain relevant information of the AMF from other function(s) in the core network based on the sensing location information, thereby directly determining the AMF.

In an example, the SAF may send a sensing request to the AMF, and the sensing request may carry an event trigger parameter. In an example, the sensing request may also carry identity information of the gNB. In an example, the sensing request may also carry sensing location information.

In an example, after receiving the sensing request from SAF, AMF may obtain the event trigger parameter from the sensing request. After that, AMF may determine the gNB. In an example, in a case where the sensing request carries identity information of the gNB, AMF may directly determine the gNB corresponding to the identity information. In an example, in a case where the sensing request carries sensing location information, AMF may determine the gNB based on the sensing location information. In this case, the gNB should meet the following condition(s): the coverage of the gNB covers the location indicated by the sensing service information; and/or, the distance between at least one gNB connected to the AMF and the location is the shortest, or is less than or equal to a preset distance. In this case, AMF may determine a gNB that meets the above condition(s) based on the sensing location information. In an embodiment, a second gNB may be all gNB(s) connected to the AMF.

In an example, the AMF may send a sensing request to a determined gNB, and may carry an event trigger parameter in the sensing request.

It is understandable that, in addition to the sensing location information, the SAF may also consider the range requirement information and/or accuracy requirement information carried in the sensing request message in the procedure of determining the gNB. Specifically, the SAF may compare the range requirement information and/or accuracy requirement information carried in the sensing request message with the sensing value range and/or sensing accuracy corresponding to gNB(s) determined according to the sensing location information to determine a gNB that meets the range requirement and/or accuracy requirement.

In an embodiment, the above sensing request may also carry sensing time information.

It should be noted that the sensing request sent by the station to the SAF and the sensing request sent by the SAF to the gNB may be collectively referred to as a sensing request, and is sent in the form of a sensing request message (also referred to as a second message).

In S305, the gNB sends a sensing response to the SAF.

After the sensing request is received in S304, the gNB determines to provide a precipitation monitoring service corresponding to the sensing request. Therefore, the gNB may send the sensing response to the SAF to indicate that the precipitation monitoring service is provided.

In an embodiment, the sensing response may also be used to indicate that the gNB starts wireless sensing for precipitation monitoring.

In S306, the SAF sends a sensing response to the station.

After the sensing response is received in S305, the SAF sends a sensing response to the station. The sensing response sent by the SAF indicates that a quantity monitoring service is provided.

In S307, the gNB performs wireless sensing.

After determining to provide the precipitation monitoring service in S304, the gNB may perform processing for the precipitation monitoring service according to the sensing request.

In an embodiment, after receiving the sensing request, the gNB may directly start wireless sensing of precipitation according to the sensing request.

In an embodiment, in a case where the sensing request carries sensing time information, the gNB may perform wireless sensing of precipitation based on the sensing time information.

It can be understood that the gNB may obtain the sensing data of precipitation by performing wireless sensing.

In S308, the gNB sends (or reports) the sensing data to the SAF.

In an embodiment, since the sensing request carries the event trigger parameter, the gNB may perform wireless sensing based on the event trigger parameter. For example, in a case where the event trigger parameter includes the reporting period, the gNB may send the sensing data to the SAF according to the reporting period. For another example, in a case where the event trigger parameter includes the precipitation threshold, the gNB may send the sensing data to the SAF when the sensed precipitation reaches the precipitation threshold.

In an embodiment, the sensing data sent by the gNB may be raw data.

It should be noted that if the gNB has sufficient computing power, after the gNB performs wireless sensing to obtain the raw data, the gNB may perform data processing on the raw data to obtain a sensing result, and then send the sensing result to the SAF.

It is understandable that the gNB may report the sensing data to SAF in multiple ways. In a first way, the gNB may send the sensing data to the SAF according to the IP address of the SAF. In a second way, the gNB can send the sensing data to the SAF via an AMF. It should be noted that the gNB may also send the sensing data to the SAF in other ways, which is not specifically limited in the embodiments of the present disclosure.

In S309, the SAF sends the sensing result to the station.

After the sensing data from the gNB is received in S308, the SAF determines the sensing result of the precipitation monitoring service.

In an embodiment, the SAF receives the sensing data from the gNB. At this time, the SAF may perform data processing on the sensing data to obtain a sensing result.

In an embodiment, in a case where the gNB sends the sensing result to the SAF, the SAF may use the received sensing result as the sensing result to be sent. In an embodiment, in a case where the gNB sends the sensing data to the SAF, the SAF may send the sensing data to the station.

It is understandable that the sensing result may be a precipitation value, for example, the precipitation in the past one hour, the precipitation in the past 24 hours. Alternatively, the sensing result may be information indicating whether a precipitation threshold is reached. For example, the sensing result may indicate that the precipitation has reached a precipitation threshold, such as 200 mm/day. After determining the sensing result of the precipitation monitoring service, the SAF may send the determined sensing result to the station.

In S310, the station sends a sensing stop request to the gNB via the SAF.

After the station receives the sensing result reported by the SAF, the station may send a sensing stop request to gNG via the SAF to stop the provision of the precipitation monitoring service.

In S311, the gNB sends a stop response to the station via the SAF.

After receiving the sensing stop request, the gNB may stop the wireless sensing and send a stop response (stop acknowledgement) to the station via the SAF.

It should be noted that S310 and S311 are optional. In an embodiment, in a case where the sensing request received by the gNB in S304 carries the sensing time information and the sensing time information includes an end time or a duration, the gNB may autonomously stop the wireless sensing at the end time indicated by the sensing time information or after the duration is reached.

At this point, the procedure of the precipitation monitoring method based on the sensing service shown in FIG. 3 is completed.

In the embodiments of the present disclosure, the event trigger parameter required to implement the precipitation monitoring service is sent to the access network function, and the access network function performs precipitation monitoring and feeds back the sensing data according to the received event trigger parameter. In this way, the embodiments of the present disclosure can provide a sensing service for precipitation monitoring based on usage of a mobile network, thereby realizing large-scale and low-cost precipitation monitoring.

Based on the same inventive concept, an embodiment of the present disclosure also provides a precipitation monitoring method based on a sensing service. The method may be applied to a network function, such as an SAF. FIG. 4 is a schematic flowchart of a precipitation monitoring method based on a sensing service in an embodiment of the present disclosure. As shown in FIG. 4, the method includes: S401 to S403.

In S401, a first message sent by a sensing requester device is received.

The first message carries an event trigger parameter for a precipitation monitoring service, and the event trigger parameter is used to indicate a reporting event for triggering reporting of sensing data of the precipitation monitoring service.

In S402, a second message is sent according to the first message.

The second message carries the event trigger parameter.

In S403, the sensing data reported by an access network function is received.

In some possible implementations, the event trigger parameter may include at least one of the following: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the operation S402 of sending the second message according to the first message may include: sending the second message to the access network function via a core network function.

In some possible implementations, before the operation S401 of receiving the first message sent by the sensing requester device, the method may further include: receiving sensing capability information, where the sensing capability information is used to indicate that the access network function supports the precipitation monitoring service.

In some possible implementations, the operation of receiving the sensing capability information may include: receiving a registration request message, where the registration request message carries the sensing capability information.

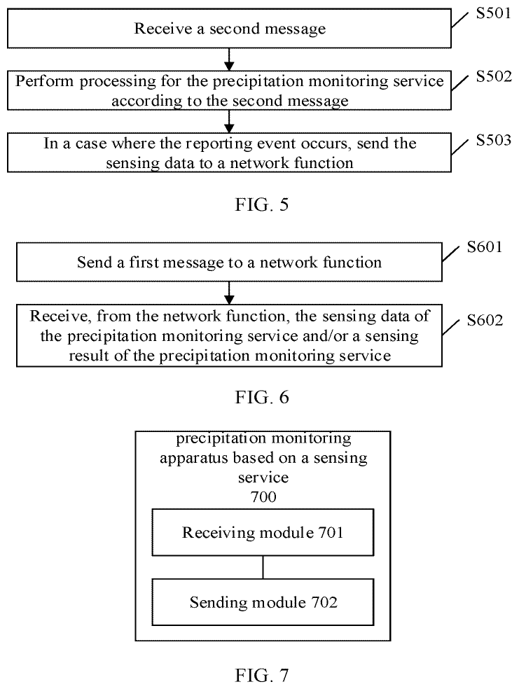

Based on the same inventive concept, an embodiment of the present disclosure also provides a precipitation monitoring method based on a sensing service. The method may be applied to an access network function, such as a gNB. FIG. 5 is a schematic flowchart of another precipitation monitoring method based on a sensing service in an embodiment of the present disclosure. As shown in FIG. 5, the method includes: S501 to S503.

In S501, a second message is received.

The second message carries an event trigger parameter for a precipitation monitoring service, and the event trigger parameter is used to indicate a reporting event for triggering reporting of sensing data of the precipitation monitoring service.

In S502, processing for the precipitation monitoring service is performed according to the second message.

In S503, in a case where the reporting event occurs, the sensing data is sent to a network function.

In some possible implementations, the event trigger parameter may include at least one of the following: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

In some possible implementations, the operation of receiving the second message may include: receiving the second message sent by the network function via a core network function.

In some possible implementations, before the operation S501 of receiving the second message, the method may further include: sending sensing capability information, where the sensing capability information is used to indicate that the access network function supports the precipitation monitoring service.

In some possible implementations, the operation of sending the sensing capability information may include: sending a registration request message, where the registration request message carries the sensing capability information.

Based on the same inventive concept, an embodiment of the present disclosure also provides a precipitation monitoring method based on a sensing service. The method may be applied to a sensing requester device, such as a station. FIG. 6 is a schematic flowchart of another precipitation monitoring method based on a sensing service in an embodiment of the present disclosure. As shown in FIG. 6, the method includes: S601 and S602.

In S601, a first message is sent to a network function.

The first message carries an event trigger parameter for a precipitation monitoring service, and the event trigger parameter is used to indicate a reporting event for triggering reporting of sensing data of the precipitation monitoring service.

In S602, the sensing data of the precipitation monitoring service and/or a sensing result of the precipitation monitoring service from the network function is (are) received.

In some possible implementations, the event trigger parameter may include at least one of the following: a reporting period; a precipitation threshold.

In some possible implementations, the event trigger parameter may include the reporting period, and the reporting event is that the reporting period is reached.

In some possible implementations, the event trigger parameter may include the precipitation threshold, and the reporting event is that precipitation sensed by the access network function reaches the precipitation threshold.

It should be noted that, in the embodiments of the present disclosure, regarding the execution procedures at the network function side, the access network function side and the sensing requester device side, reference may be made to the detailed descriptions of the precipitation monitoring procedure based on the sensing service in the embodiments of FIG. 3 above. For the sake of brevity of the specification, repeated description will be omitted here.

Based on the same inventive concept, an embodiment of the present disclosure also provides a precipitation monitoring apparatus based on a sensing service. FIG. 7 is a schematic structural schematic diagram of a precipitation monitoring apparatus based on a sensing service in an embodiment of the present disclosure. As shown in FIG. 7, the apparatus 700 includes: a receiving module 701 and a sending module 702.

In an embodiment, the apparatus 700 may be set in a network function. The receiving module 701 is configured to receive a first message sent by a sensing requester device, where the first message carries an event trigger parameter for a precipitation monitoring service, and the event trigger parameter is used to indicate a reporting event for triggering reporting of sensing data of the precipitation monitoring service. The sending module 702 is configured to send a second message according to the first message, where the second message carries the event trigger parameter. The receiving module 701 is further configured to receive sensing data reported by an access network function.

In some possible implementations, the event triggering parameter may include at least one of the following: a reporting period; a precipitation threshold.

In some possible implementations, the event triggering parameter may include the reporting period, and the reporting event is that the reporting period is reached.

In some possible implementations, the event triggering parameter may include the precipitation threshold, and the reporting event is that precipitation sensed by the access network function reaches the precipitation threshold.

In some possible implementations, the sending module 702 may be configured to: send the second message to the access network function via a core network function.

In some possible implementations, the receiving module 701 is further configured to: receive sensing capability information, where the sensing capability information is used to indicate that the access network function supports the precipitation monitoring service.

In some possible implementations, the receiving module 701 is configured to: receive a registration request message, where the registration request message carries the sensing capability information.

In an embodiment, the apparatus 700 may be set in a sensing requester device. The sending module 702 is configured to send a first message to a network function, where the first message carries an event trigger parameter for a precipitation monitoring service, and the event trigger parameter is used to indicate a reporting event for triggering reporting of sensing data of the precipitation monitoring service. The receiving module 701 is configured to receive, from the network function, the sensing data of the precipitation monitoring service and/or a sensing result of the precipitation monitoring service.

In some possible implementations, the event triggering parameter may include at least one of the following: a reporting period; a precipitation threshold.

In some possible implementations, the event triggering parameter may include the reporting period, and the reporting event is that the reporting period is reached.

In some possible implementations, the event triggering parameter may include the precipitation threshold, and the reporting event is that precipitation sensed by the access network function reaches the precipitation threshold.

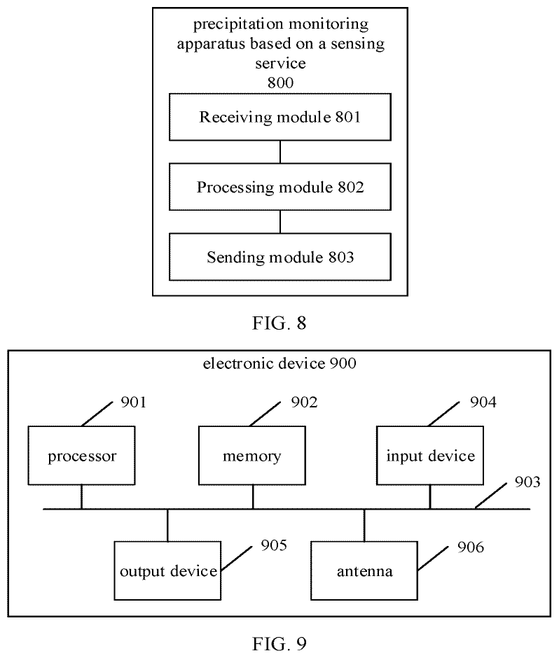

Based on the same inventive concept, an embodiment of the present disclosure also provides a precipitation monitoring apparatus based on a sensing service. The apparatus may be set in an access network function. FIG. 8 is a schematic structural diagram of another precipitation monitoring apparatus based on a sensing service in the embodiment of the present disclosure. As shown in FIG. 8, the apparatus 800 includes: a receiving module 801, a processing module 802 and a sending module 803. The receiving module 801 is configured to receive a second message, where the second message carries an event trigger parameter for a precipitation monitoring service, and the event trigger parameter is used to indicate a reporting event for triggering reporting of sensing data of the precipitation monitoring service. The processing module 802 is configured to perform processing for the precipitation monitoring service according to the second message. The sending module 803 is configured to send the sensing data to the network function in a case where the reporting event occurs.

In some possible implementations, the event triggering parameter may include at least one of the following: a reporting period; a precipitation threshold.

In some possible implementations, the event triggering parameter may include the reporting period, and the reporting event is that the reporting period is reached.

In some possible implementations, the event triggering parameter may include the precipitation threshold, and the reporting event is that precipitation sensed by the access network function reaches the precipitation threshold.

In some possible implementations, the receiving module 802 may be configured to: receive the second message sent by the network function via a core network function.

In some possible implementations, the sending module 801 may be further configured to: send sensing capability information, where the sensing capability information is used to indicate that the access network function supports the precipitation monitoring service.

In some possible implementations, the sending module 801 may be configured to: send a registration request message, where the registration request message carries the sensing capability information.

It should be noted that regarding the specific implementation procedure of one or more of the processing module, the receiving module and the sending module in FIG. 7 and FIG. 8, reference may be made to the detailed description of the procedure of precipitation monitoring based on the sensing service in the embodiments of FIG. 3. For the sake of brevity of the specification, repeated description will be omitted here.

The receiving module mentioned in the embodiments of the present disclosure may be a receiving interface, a receiving circuit or a receiver, etc.; the sending module may be a sending interface, a sending circuit or a transmitter, etc.; the processing module may be one or more processors.

Based on the same inventive concept, an embodiment of the present disclosure provides a core network device. The core network device is configured to: receive a first message sent by a sensing requester device, where the first message carries an event trigger parameter for a precipitation monitoring service, and the event trigger parameter is used to indicate a reporting event for triggering reporting of sensing data of the precipitation monitoring service; according to the first message, send a second message to an access network function, where the second message carries the event trigger parameter; and receive the sensing data reported by the access network function.

In some possible implementations, the event triggering parameter may include at least one of the following: a reporting period; a precipitation threshold.

In some possible implementations, the event triggering parameter may include the reporting period, and the reporting event is that the reporting period is reached.

In some possible implementations, the event triggering parameter may include the precipitation threshold, and the reporting event is that precipitation sensed by the access network function reaches the precipitation threshold.

In some possible implementations, the core network device may include: a network function and a core network function. The network function is configured to: receive the first message sent by the sensing requester device; and send the second message to the core network function according to the first message. The core network function is configured to: receive the second message and send the second message to the access network function; receive the sensing data reported by the access network function, and send the sensing data to the network function.

In some possible implementations, the core network function may be further configured to: receive sensing capability information from the access network function, where the sensing capability information is used to indicate that the access network function supports the precipitation monitoring service; and send the sensing capability information to the network function. The network function may be further configured to: receive the sensing capability information sent by the core network function.

Based on the same inventive concept, an embodiment of the present disclosure provides an electronic device, which may be the network function, the access network function, or the sensing requester device described in one or more of the above embodiments. FIG. 9 is a schematic diagram of the structure of an electronic device in an embodiment of the present disclosure. As shown in FIG. 9, the electronic device 900 uses general computer hardware, including a processor 901, a memory 902, a bus 903, an input device 904, and an output device 905.

In some possible implementations, the memory 902 may include computer storage media in the form of volatile and/or non-volatile memory, such as a read-only memory and/or a random access memory. The memory 902 may store an operating system, an application program, other program module(s), an executable code, program data, user data, etc.

The input device 904 may be used to input commands and information to the electronic device, such as a keyboard or a pointing device, for example, a mouse, a trackball, a touch pad, a microphone, a joystick, a game pad, a satellite TV antenna, a scanner or a similar device. These input devices may be connected to the processor 901 via the bus 903.

The output device 905 may be used for outputting information by the electronic device. In addition to a monitor, the output device 905 may also be other peripheral output device(s), such as a speaker and/or a printing device. These output devices may also be connected to the processor 901 through the bus 903.

The electronic device may be connected to a network, such as a Local Area Network (LAN), via an antenna 906. In a network-connected environment, computer-executable instructions stored in the control device may be stored in a remote storage device, rather than being limited to local storage.

When the processor 901 in the electronic device executes the executable code or an application program stored in the memory 902, the electronic device perform the method for providing the wireless the sensing service at the electronic device side, the access network function entity side, or the network function entity side in the above embodiments. For the specific execution procedure, reference may be made to the above embodiments and repeated descriptions will be omitted here.

Based on the same inventive concept, an embodiment of the present disclosure provides a network device (e.g., an access network device, a sensing requester device). The network device is consistent with the access network function or the network function in one or more of the above embodiments.

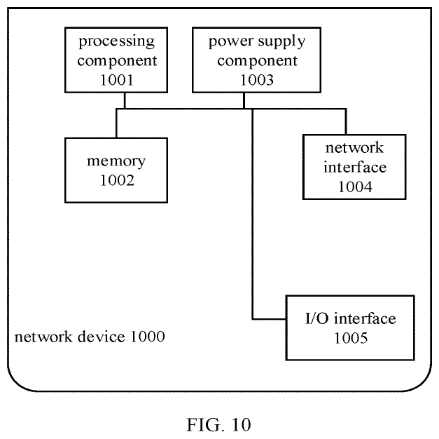

FIG. 10 is a schematic diagram of the structure of a network device in an embodiment of the present disclosure. As shown in FIG. 10, the network device 1000 may include a processing component 1001, which further includes one or more processors, and a memory resource represented by a memory 1002 for storing instructions executable by the processing component 1001, such as an application program. The application program stored in the memory 1002 may include one or more modules, each corresponding to a set of instructions. In addition, the processing component 1001 is configured to execute the instructions to perform any one of the aforementioned methods applied to the access network function entity, the core network function entity or the network function entity.

The network device 1000 may further include a power supply component 1003 configured to perform power management of the network device 1000, a wired or wireless network interface 1004 configured to connect the network device 1000 to a network, and an input/output (I/O) interface 1005. The network device 1000 may operate based on an operating system stored in the memory 1002, such as Windows Server™, Mac OS X™ Unix™, Linux™, FreeBSD™, or the like.

Based on the same inventive concept, an embodiment of the present disclosure also provides a computer-readable storage medium, on which computer executable instructions are stored. After the computer executable instructions are executed by a processor, the precipitation monitoring method based on the sensing service at the access network function side, the network function side, or the sensing requester device side in one or more of the above embodiments cab be implemented.

Based on the same inventive concept, an embodiment of the present disclosure also provides a computer program or a computer program product. When the computer program product is executed on a computer, the computer is caused to implement the precipitation monitoring method based on the sensing service at the access network function side, the network function side, or the sensing requester device side in one or more of the above embodiments.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It should be noted that, since the embodiments are based on the same inventive concept, the function(s) of the same parameter(s) and signaling in different embodiments is (are) also the same, and therefore is (are) not explained separately in each embodiment.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A precipitation monitoring method based on a sensing service, applied to a network function, and the method comprising:
receiving a first message sent by a sensing requester device, wherein the first message carries an event trigger parameter for a precipitation monitoring service, and the event trigger parameter is used to indicate a reporting event for triggering reporting of sensing data of the precipitation monitoring service;
sending a second message according to the first message, wherein the second message carries the event trigger parameter; and
receiving the sensing data reported by the access network function.

2. The method according to claim 1, wherein the event trigger parameter comprises at least one of:
a reporting period;
a precipitation threshold.

3. The method according to claim 2, wherein the event trigger parameter comprises the reporting period, and the reporting event is that the reporting period is reached.

4. The method according to claim 2, wherein the event trigger parameter comprises the precipitation threshold, and the reporting event is that precipitation sensed by the access network function reaches the precipitation threshold.

5. The method according to claim 1, wherein sending the second message according to the first message comprises:
according to the first message, sending the second message to the access network function via an Access and Mobility Management Function (AMF).

6. The method according to claim 1, wherein before receiving the first message sent by the sensing requester device, the method further comprises:
receiving sensing capability information, wherein the sensing capability information is used to indicate that the access network function supports the precipitation monitoring service.

7. The method according to claim 6, wherein receiving sensing capability information comprises:
receiving a registration request message, wherein the registration request message carries the sensing capability information.

8. A precipitation monitoring method based on a sensing service, applied to an access network function, and the method comprising:
receiving a second message, wherein the second message carries an event trigger parameter for a precipitation monitoring service, and the event trigger parameter is used to indicate a reporting event for triggering reporting of sensing data of the precipitation monitoring service;
performing processing for the precipitation monitoring service according to the second message; and
in a case where the reporting event occurs, sending the sensing data to a network function.

9. The method according to claim 8, wherein the event trigger parameter comprises at least one of:
a reporting period;
a precipitation threshold.

10. The method according to claim 9, wherein the event trigger parameter comprises the reporting period, and the reporting event is that the reporting period is reached.

11. The method according to claim 9, wherein the event trigger parameter comprises the precipitation threshold, and the reporting event is that precipitation sensed by the access network function reaches the precipitation threshold.

12. The method according to claim 8, wherein receiving the second message comprises:
receiving the second message sent by the network function via an Access and Mobility Management Function (AMF).

13. The method according to claim 8, wherein before receiving the second message, the method further comprises:
sending sensing capability information, wherein the sensing capability information is used to indicate that the access network function supports the precipitation monitoring service.

14. The method according to claim 13, wherein sending the sensing capability information comprises:
sending a registration request message, wherein the registration request message carries the sensing capability information.

15. A precipitation monitoring method based on a sensing service, applied to a sensing requester device, and the method comprising:
sending a first message to a network function, wherein the first message carries an event trigger parameter for a precipitation monitoring service, and the event trigger parameter is used to indicate a reporting event for triggering reporting of sensing data of the precipitation monitoring service; and
receiving, from the network function, the sensing data of the precipitation monitoring service and/or a sensing result of the precipitation monitoring service.

16. The method according to claim 15, wherein the event trigger parameter comprises at least one of:
a reporting period;
a precipitation threshold.

17. The method according to claim 16, wherein the event trigger parameter comprises the reporting period, and the reporting event is that the reporting period is reached.

18. The method according to claim 16, wherein the event trigger parameter comprises the precipitation threshold, and the reporting event is that precipitation sensed by the access network function reaches the precipitation threshold.

19. A precipitation monitoring method based on a sensing service, applied to a core network device, and the method comprising:
receiving a first message sent by a sensing requester device, wherein the first message carries an event trigger parameter for a precipitation monitoring service, and the event trigger parameter is used to indicate a reporting event for triggering reporting of sensing data of the precipitation monitoring service;
sending a second message to an access network function according to the first message, wherein the second message carries the event trigger parameter; and
receiving the sensing data reported by the access network function.

20. The method according to claim 19, wherein the event trigger parameter comprises at least one of:
a reporting period;
a precipitation threshold.

21. The method according to claim 20, wherein the event trigger parameter comprises the reporting period, and the reporting event is that the reporting period is reached.

22. The method according to claim 20, wherein the event trigger parameter comprises the precipitation threshold, and the reporting event is that precipitation sensed by the access network function reaches the precipitation threshold.

23. The method according to claim 19, wherein the core network device comprises a Sensing Application Function (SAF) and an Access and Mobility Management Function (AMF);
wherein receiving the first message sent by the sensing requester device comprises:
receiving, by the SAF, the first message sent by the sensing requester device;
wherein sending the second message to the access network function according to the first message comprises:
sending, by the SAF, the second message to the AMF according to the first message; and
sending, by the AMF, the second message to the access network function.

24. The method according to claim 19, wherein the core network device comprises an SAF and an AMF,
wherein receiving the sensing data reported by the access network function comprises:
receiving, by the AMF, the sensing data reported by the access network function;
wherein the method further comprises:
sending, by the AMF, the sensing data to the SAF.

25. The method according to claim 23 or 24, further comprising:
receiving, by the AMF, sensing capability information from the access network function, wherein the sensing capability information is used to indicate that the access network function supports the precipitation monitoring service; and
sending, by the AMF, the sensing capability information to the SAF.

26. A precipitation monitoring apparatus based on a sensing service, set in a network function, and comprising a receiving module and a sending module;
wherein the receiving module is configured to receive a first message sent by a sensing requester device, the first message carries an event trigger parameter for a precipitation monitoring service, and the event trigger parameter is used to indicate a reporting event for triggering reporting of sensing data of the precipitation monitoring service;
wherein the sending module is configured to send a second message according to the first message, wherein the second message carries the event trigger parameter;
wherein the receiving module is further configured to receive the sensing data reported by the access network function.

27. A precipitation monitoring apparatus based on a sensing service, set in an access network function, and comprising a receiving module, a processing module and a sending module;
wherein the receiving module is configured to receive a second message, wherein the second message carries an event trigger parameter for a precipitation monitoring service, and the event trigger parameter is used to indicate a reporting event for triggering reporting of sensing data of the precipitation monitoring service;
wherein the processing module is configured to perform processing for the precipitation monitoring service according to the second message;
wherein the sending module is configured to send the sensing data in a case where the reporting event occurs.

28. A precipitation monitoring apparatus based on a sensing service, set in a sensing requester device, and comprising a receiving module and a sending module;
wherein the sending module is configured to send a first message to a network function, wherein the first message carries an event trigger parameter for a precipitation monitoring service, and the event trigger parameter is used to indicate a reporting event for triggering reporting of sensing data of the precipitation monitoring service;
wherein the receiving module is configured to receive, from the network function, the sensing data of the precipitation monitoring service and/or a sensing result of the precipitation monitoring service.

29. A core network device configured to:
receive a first message sent by a sensing requester device, wherein the first message carries an event trigger parameter for a precipitation monitoring service, and the event trigger parameter is used to indicate a reporting event for triggering reporting of sensing data of the precipitation monitoring service;
send a second message to an access network function according to the first message, where the second message carries the event trigger parameter; and
receive the sensing data reported by the access network function.

30. The core network device according to claim 29, wherein the event trigger parameter comprises at least one of:
a reporting period;
a precipitation threshold.

31. The core network device according to claim 30, wherein the event trigger parameter comprises the reporting period, and the reporting event is that the reporting period is reached.

32. The core network device according to claim 30, wherein the event trigger parameter comprises the precipitation threshold, and the reporting event is that precipitation sensed by the access network function reaches the precipitation threshold.

33. An electronic device, comprising:
a memory configured to store computer executable instructions; and
a processor connected to the memory;
wherein the processor is configured to execute the computer executable instructions in the memory to implement the precipitation monitoring method based on the sensing service according to any one of claims 1 to 25.

34. A computer storage medium having computer executable instructions stored thereon, wherein after the computer executable instructions are executed by a processor, the precipitation monitoring method based on the sensing service according to any one of claims 1 to 25 is implemented.
